(19) United States
(12) Patent Application Publication
(10) Pub. No.: US 2011/0236119 A1
(43) Pub. Date: Sep. 29, 2011

(54) Block Crayon

(76) Inventor: Kevin Richer, Montreal (CA)

(21) Appl. No.: 12/731,175

(22) Filed: Mar. 25, 2010

(51) Int. Cl. B43K 27/00; B43K 23/00

(52) U.S. Cl. 401/35; 401/88

(57) ABSTRACT

The Block Crayons have the perfect shape and size to fit children's little hands. The shape is duplicated on a same piece to create a double point crayon allowing the child to draw with a dual writing crayon. In addition to the double point, the crayons are shaped to fit one into the other.

Just like construction block the crayons are stackable.

The Block Crayon is a drawing & game activity for children for one year old to four older.

The traditional wax crayon has been part of the artistic basics for years. The wax crayon has seen its size & shape change over the years for esthetic and functional purposes. The traditional crayons are one of the most popular drawing & writing tool for children. Some crayons have even been adapted for the toddler's first marks between one (1) and three (3) years old.

Based on the crayon called “ Crayon a doigt/Finger Crayon” or “ Crayon Plastique” we created a new version of the crayon, adding an other creativity fonction to the crayon. The crayon now have a perfect shape and size to fit little children's hands. The shape is duplicated on a same piece to create a double point crayon allowing the child to draw with a dual writing crayon. In addition to the double point, the crayons are shaped to fit one into the other. Just like construction block the crayons are stackable.

With Block Crayon the children now have two of the most popular playtime activities grouped in one; coloring & building.

General Characteristics

The invention is related to drawing & games activities for children for one year old and older.

Nature

The wax crayons on today's market are not made for young children. Their size and shape are not adapted to the little hands. The children need to be stimulated and initiated to their first drawing playtime activity. The parents are always in search for the new technology to stimulate their children's creativity.

Idea

“Block Crayon” is dedicated to young children and made for them to have fun with this new drawing tool & with the dual building & coloring activity. Kids love to stack & build things, mostly play with block, which is where the idea behind “Block crayon” comes from. The creative idea is to give the same function as a block to a crayon with double point.

### DESCRIPTION

We want to offer the young children their first crayon with a better, more fun & attractive twist.

“Block Crayon” offers more playtime possibilities than a regular wax crayon. With the dual point the wax crayon brings a whole new & fun way to scribble that you can find in the regular crayon.

Block Crayon is perfectly shaped for the little hands allowing the children to develop their creativity.

With the wax crayon the preschoolers can build & stack the block crayon & develop their dexterity.

The child can also make association with the images, numbers & letters printed on the blocks.

### BRIEF DESCRIPTION OF THE SEVERAL VIEWS OF THE DRAWINGS

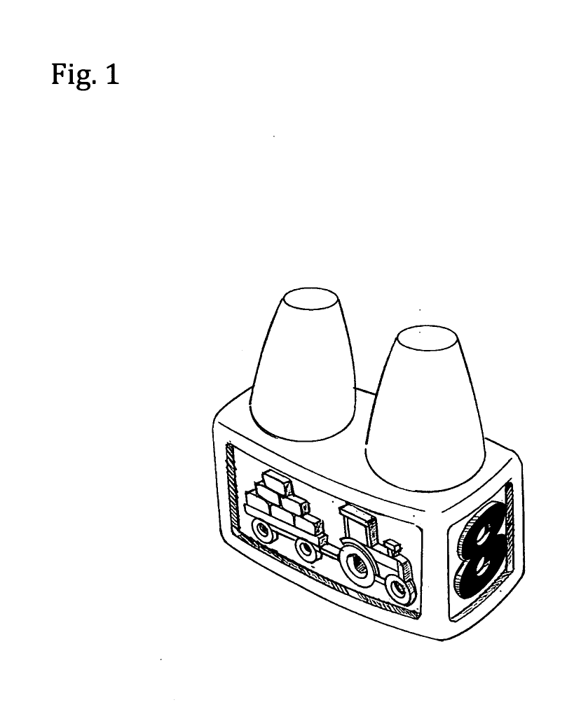

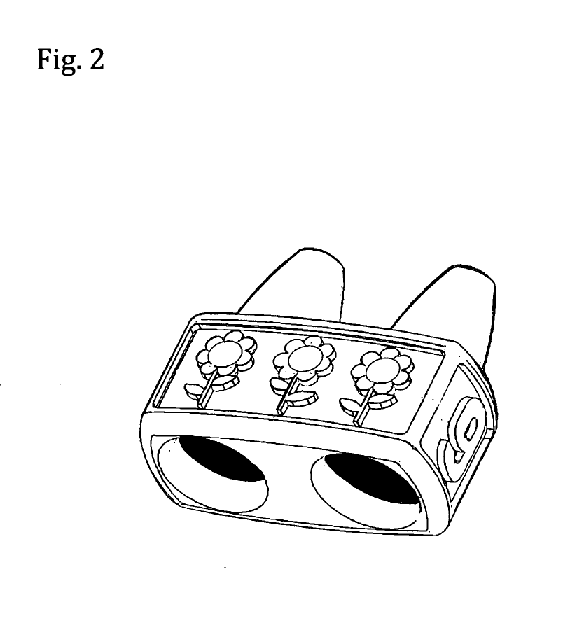

Double point & double hole reception wax crayon (FIGS. 1 and 2)

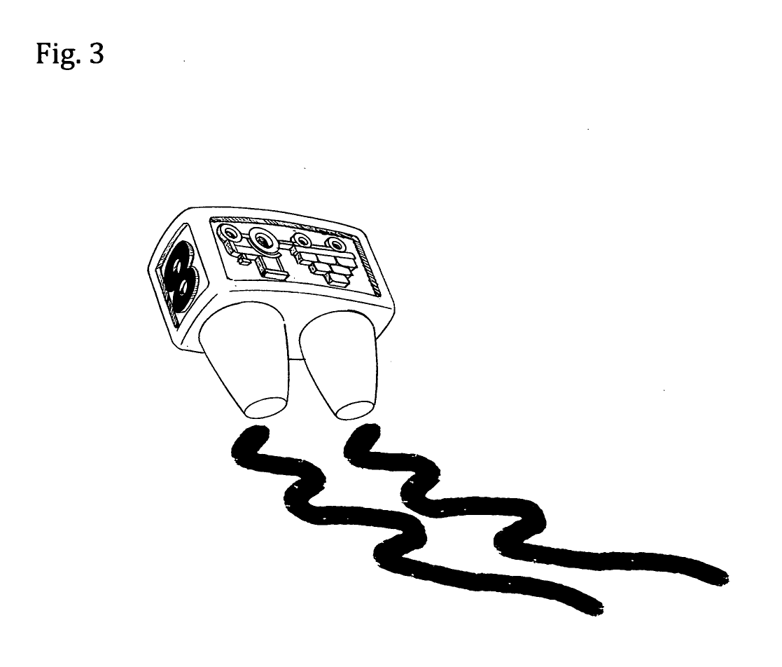

The wax crayon can draw two lines (FIG. 3)

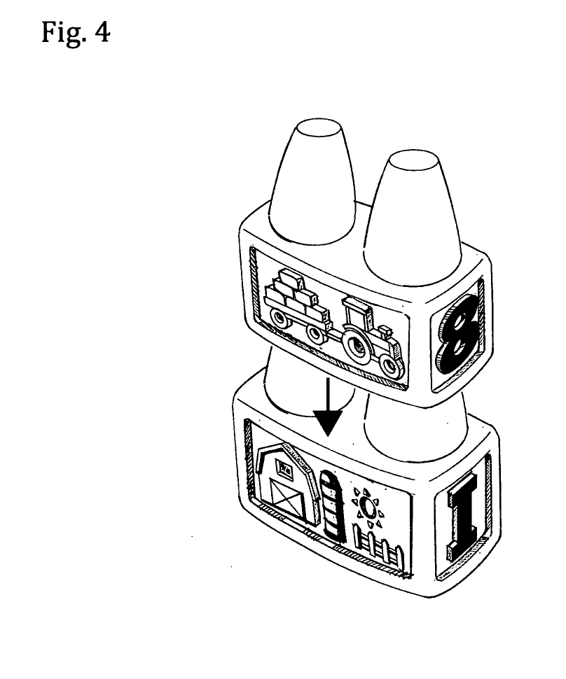

The holes underneath the wax crayon are there to able to stack & build with the block (FIG. 4)

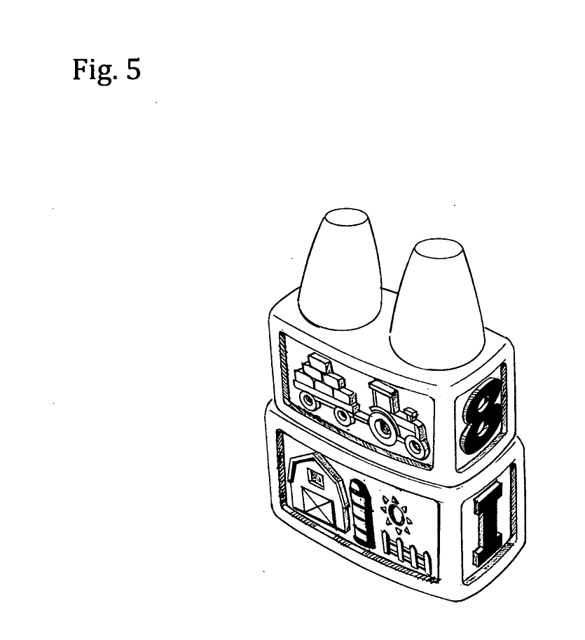

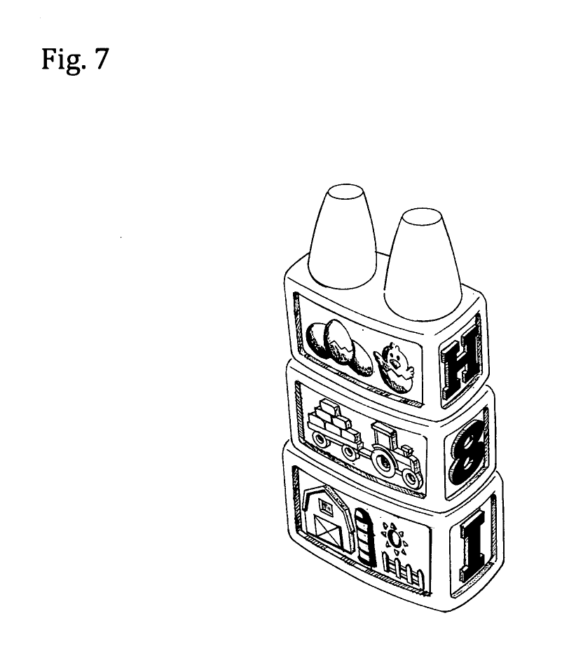

Wax crayons that can be tacked on each other in perfect alignment (FIGS. 5 and 7)

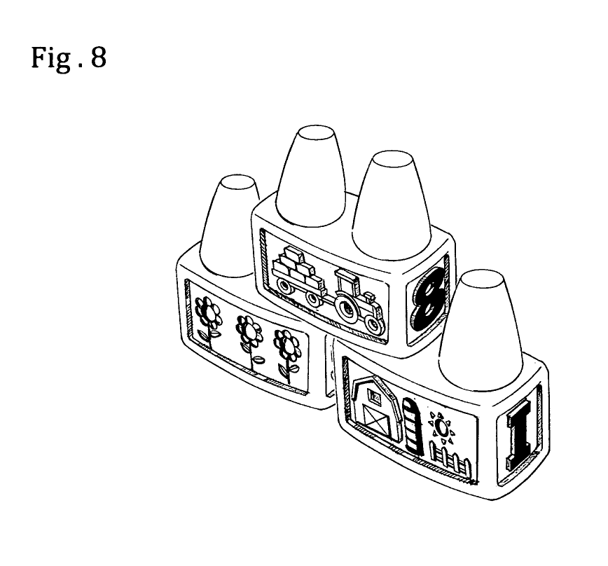

Wax crayons that can be tacked on each other in overlapping (FIG. 8)

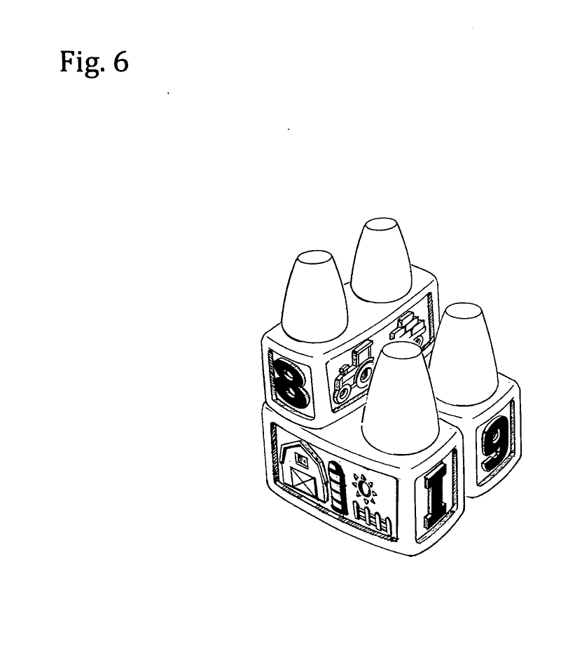

Wax crayons that can be tacked on each other across (FIG. 6)

The “Block Crayon” is composed of a rectangular cubic base with two (2) drawing points on the top (FIG. 1) and two (2) holes underneath the base to stack the crayons (FIG. 2).

On the four (4) side of the rectangular base are inlayed a number, a letter and an image on both of the other two (2) sides.

The holes underneath the block are there to able to stack & build with the block (FIG. 4)

The block crayon can be stack in different ways: Aligned (FIG. 7), over lap (FIG. 8), or across (FIG. 6).

The double points allow the child to draw two (2) lines at once. (FIG. 3)

1. A. Double point & double hole reception wax crayon (FIG. 1 and FIG. 2)
B. The wax crayon can draw two lines (FIG. 3)
C. The holes underneath the wax crayon are there to able to stack & build with the block (FIG. 4)
D. Wax crayons that can be tacked on each other in perfect alignment (FIG. 5 and FIG. 7)
E. Wax crayons that can be tacked on each other in overlapping (FIG. 8)
F. Wax crayons that can be tacked on each other across (FIG. 6)
